(19) United States
(12) Patent Application Publication
(10) Pub. No.: US 2018/0313328 A1
(43) Pub. Date: Nov. 1, 2018

(54) Wind Power Generation Device

(71) Applicants: Nan Zhang, Ha Er Bin, Heilongjiang (CN); Yongkun Zhang, Nanjing, Jiangsu (CN); Shunzi Li, Ha Er Bin, Heilongjiang (CN); Deshan Shen, Ha Er Bin, Heilongjiang (CN)

(72) Inventors: Nan Zhang, Ha Er Bin, Heilongjiang (CN); Yongkun Zhang, Nanjing, Jiangsu (CN); Shunzi Li, Ha Er Bin, Heilongjiang (CN); Deshan Shen, Ha Er Bin, Heilongjiang (CN)

(21) Appl. No.: 15/654,685

(22) Filed: Jul. 19, 2017

(30) Foreign Application Priority Data
Apr. 27, 2017 (CN) 201710288711.7

(51) Int. Cl. F03D 9/25; F03D 3/00; F03D 80/70; H02K 7/18; H02K 16/00; H02K 7/08

(52) U.S. Cl. CPC F03D 9/25; F03D 3/005; F03D 80/70; F03D 3/062; H02K 16/005; H02K 7/083; H02K 7/1838

(57) ABSTRACT

Wind power generation device, the inner surface of the front sleeve is fastened to the outer surface of the outer ring of the bearing II, and the inner surface of the inner ring of the bearing II is fastened to the rotary axle, the rotary axle passes through the center of the magnet, The outer surface of the end of the front sleeve is provided with a electric brush, the front end of the electric brush is provided with one end of the winding coil, the winding coil is filled with a magnet, the outer surface of the rotary axle is fitted with a rear sleeve, The inner surface of the rear sleeve passes through the rotary axle, the device which was invented used to generate electricity.

### FIELD OF THE INVENTION

The invention refer to wind power generation device.

### DESCRIPTION OF PRIOR ART

Now more and more people pay attention to energy conservation and environmental protection, because of the huge energy consumption of our staff, making some areas in the electricity peak staggered power outages to ease the electricity pressure, but this is a great inconvenience to the daily life of residents, and this action can only reduce the consumption of electricity, there is no fundamental increase radically in the same time within the power generation problem.

### BRIEF SUMMARY OF THE INVENTION

The purpose of the invention to provide a wind power generation device which can solve the above problems and which can increase the amount of electricity generated at the same time.

The above purpose is achieved by the following technical scheme:

Wind power generation device, comprising: a front vane and a rear vane, a set of front vanes evenly installed in the front rounded disc, the center of front rounded disc is passed through the front sleeve, the outer end of the front sleeve is connected to the inner ring of the bearing I, and the outer surface of the bearing I is connected to the guide plate;

The inner surface of the front sleeve is fastened to the outer surface of the outer ring of the bearing II, and the inner surface of the inner ring of the bearing II is fastened to the rotary axle, the rotary axle passes through the center of the magnet, The outer surface of the end of the front sleeve is provided with a electric brush, the front end of the electric brush is provided with one end of the winding coil, the winding coil is filled with a magnet, the outer surface of the rotary axle is fitted with a rear sleeve, The inner surface of the rear sleeve passes through the rotary axle;

The rear end of the rear sleeve passing through the center of the rear rounded disc, a set of rear vanes evenly installed in the rear rounded disc.

The front end of the magnet, the winding coil and the rear sleeve, and the rear end of the front sleeve are fitted into the cylindrical shell.

The two rounded ends of the two cylindrical shells are respectively provided with center holes, and the two center holes are respectively passed through the front end of the rear sleeve and the rear end of the front sleeve.

The center of the outer surface of the cylindrical shell is positioned through a screw, the screw passing through the inner ring of bearing, the bearing being arranged at the outer surface of the cylindrical shell.

The brush is connected with a plurality of power supply output lines, the power supply output lines passing through the center of the screw.

### Beneficial Effects

1. The rear sleeve of the invention rotates in the opposite direction to the front sleeve so that the rate of cutting of the magnetic field lines is doubled at the same time and the amount of power generation is doubled.

2. The front vane of the invention is used in conjunction with the rear vane, and the power generation is increased by at least 92% due to the rotation of the two sets of vanes in the opposite direction

3. The invention is a clean energy, it can reduce the thermal power generated by carbon dioxide and harmful gases, and it also can reduces the occurrence of haze.

4. The bottom fulcrum of the invention can be freely rotated according to the wind direction so that each wind direction can generate electricity and increase the power generation amount.

### BRIEF DESCRIPTION OF THE SEVERAL VIEWS OF THE DRAWINGS

FIG. 1 is a structure schematic view of the invention.

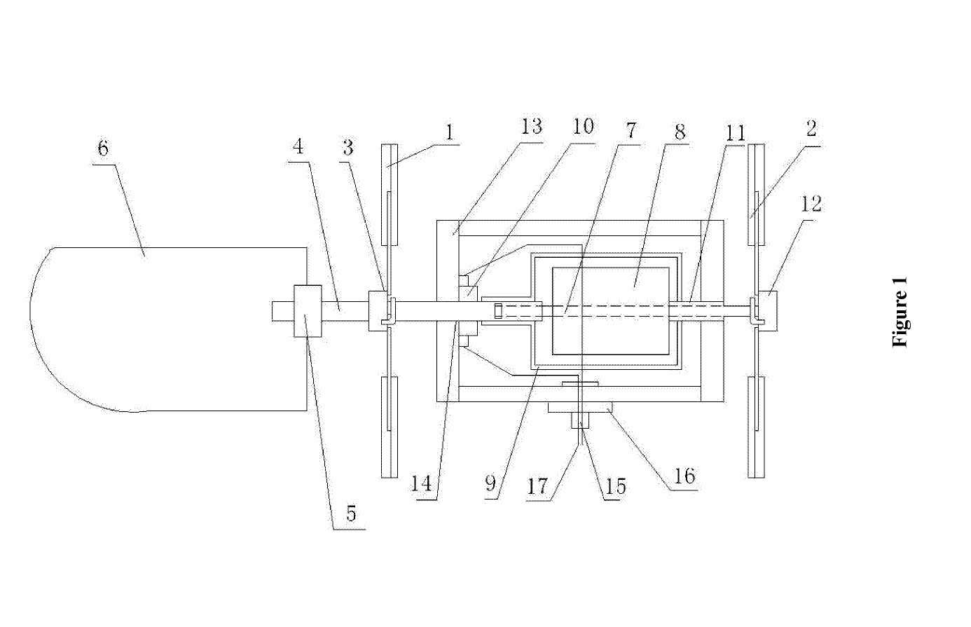

FIG. 2 is a structure schematic view of the vane.

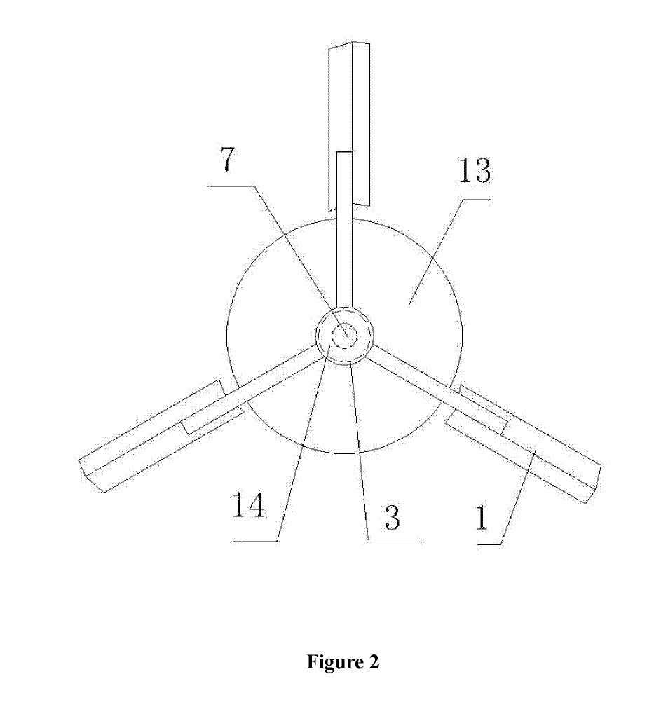

### DETAILED DESCRIPTION OF THE INVENTION

### Embodiment 1

Wind power generation device, comprising: a front vane 1 and a rear vane 2, a set of front vanes 1 evenly installed in the front rounded disc 3, the center of front rounded disc 3 is passed through the front sleeve 4, The outer end of the front sleeve 4 is connected to the inner ring of the bearing I 5, and the outer surface of the bearing I 5 is connected to the guide plate 6;

The inner surface of the front sleeve 4 is fastened to the outer surface of the outer ring of the bearing II 18, and the inner surface of the inner ring of the bearing II 18 is fastened to the rotary axle 7, the rotary axle 7 passes through the center of the magnet 8, The outer surface of the end of the front sleeve 4 is provided with a electric brush 10, the front end of the electric brush 10 is provided with one end of the winding coil 9, the winding coil 9 is filled with a magnet 8, the outer surface of the rotary axle 7 is fitted with a rear sleeve 11, The inner surface of the rear sleeve 11 passes through the rotary axle 7;

The rear end of the rear sleeve 11 passing through the center of the rear rounded disc 12, a set of rear vanes 2 evenly installed in the rear rounded disc 12.

### Embodiment 2

The wind power generation device of embodiment 1, the front end of the magnet 8, the winding coil 9, shaft coupling II 10 and the rear sleeve 11, and the rear end of the front sleeve 4 are fitted into the cylindrical shell 13.

### Embodiment 3

The wind power generation device of embodiment 2, the two rounded ends of the two cylindrical shell 13 are respectively provided with center holes 14, and the two center holes 14 are respectively passed through the front end of the rear sleeve 11 and the rear end of the front sleeve 4.

### Embodiment 4

The wind power generation device of embodiment 2, the center of the outer surface of the cylindrical shell 13 is positioned through a screw 15, the screw 15 passing through the inner ring of bearing 16, the bearing 16 being arranged at the outer surface of the cylindrical shell 13.

### Embodiment 5

The wind power generation device of embodiment 1, the brush 10 is connected with a plurality of power supply output lines 17, the power supply output lines 17 passing through the center of the screw 15.

Operating Principle

The front sleeve 4 connected to the front vane 1 is rotated in the opposite direction to the rotary axle 7 to which the rear vane 2 is connected so that the winding coil 9 to cut the magnetic field line efficiency of the magnet 8 is multiplied.

It will be appreciated that the description and/or drawings identify and describe embodiments of the apparatus (either explicitly or non-explicitly). The apparatus may include any suitable combination and/or permutation of the technical features as identified in the detailed description, as may be required and/or desired to suit a particular technical purpose and/or technical function. It will be appreciated, that where possible and suitable, any one or more of the technical features of the apparatus may be combined with any other one or more of the technical features of the apparatus (in any combination and/or permutation). It will be appreciated that persons skilled in the art would know that technical features of each embodiment may be deployed (where possible) in other embodiments even if not expressly stated as such above. It will be appreciated that persons skilled in the art would know that other options would be possible for the configuration of the components of the apparatus to adjust to manufacturing requirements and still remain within the scope as described in at least one or more of the claims. This written description provides embodiments, including the best mode, and also enables the person skilled in the art to make and use the embodiments. The patentable scope may be defined by the claims. The written description and/or drawings may help understand the scope of the claims. It is believed that all the crucial aspects of the disclosed subject matter have been provided in this document. The foregoing has outlined the non-limiting embodiments (examples). The description is made for particular nonlimiting embodiments (examples). It is understood that the non-limiting embodiments are merely illustrative as examples.

1. Wind power generation device, comprising: a front vane and a rear vane, a set of front vanes evenly installed in the front a rounded disc, the center of front rounded disc is passed through a front sleeve, The outer end of the front sleeve is connected to the inner ring of a bearing I, and the outer surface of the bearing I is connected to a guide plate;
The inner surface of the front sleeve is fastened to the outer surface of the outer ring of the bearing II, and the inner surface of the inner ring of a bearing II is fastened to the rotary axle, a rotary axle passes through the center of a magnet, the outer surface of the end of the front sleeve is provided with an electric brush, the front end of the electric brush is provided with one end of a winding coil, the winding coil is filled with a magnet, the outer surface of the rotary axle is fitted with a rear sleeve, The inner surface of the rear sleeve passes through the rotary axle;
The rear end of the rear sleeve passing through the center of a rear rounded disc, a set of rear vanes evenly installed in the rear rounded disc.

2. According to the wind power generation device of the claim 1, wherein the front end of the magnet, the winding coil and the rear sleeve, and the rear end of the front sleeve are fitted into cylindrical shells.

3. According to the wind power generation device of the claim 2, wherein the two rounded ends of the two cylindrical shells are respectively provided with center holes, and the two center holes are respectively passed through the front end of the rear sleeve and the rear end of the front sleeve.

4. According to the wind power generation device of the claim 2, wherein the center of the outer surface of the cylindrical shell is positioned through a screw, the screw passing through the inner ring of a bearing, the bearing being arranged at the outer surface of the cylindrical shell.

5. According to the wind power generation device of the claim 1, wherein a brush is connected with a plurality of power supply output lines, the power supply output lines passing through the center of a screw.
